(19) United States
(12) Patent Application Publication
(10) Pub. No.: US 2007/0173375 A1
(43) Pub. Date: Jul. 26, 2007

(54) Method for operating the drive train of a motor vehicle

(75) Inventors: Klaus Heber, Remseck (DE); Juergen Lang, Backnang (DE); Anton Rink, Calw-Stammheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/549,693

(22) PCT Filed: Jan. 28, 2004
(86) PCT No.: PCT/EP04/00726

§ 371 Date: Jul. 26, 2006

(30) Foreign Application Priority Data
Mar. 19, 2003 (DE) 103 12 088.2

(51) Int. Cl. B60W 10/00

(52) U.S. Cl. 477/170

(57) ABSTRACT

1. A method for operating the drive train of a motor vehicle. 2.1. In a known method, with the friction clutch completely closed, a control device monitors rotational speeds upstream and downstream of the clutch. As soon as slip occurs, the control devices reduces an output torque of an engine for a limited time. The object of the invention is to propose a method, by means of which, while adhering as much as possible to a torque instruction of a vehicle driver, damage to the friction clutch and to further components of the transmission is avoided. 2.2 According to the invention, with the friction clutch slipping, the control device determines an energy quantity dissipated in the friction clutch and/or a temperature of the friction clutch. If the dissipated energy quantity and/or the temperature overshoot limit values, the control device reduces the output torque of the engine. According to a second embodiment, the output torque of the engine is reduced in steps. 2.3 Use in a motor vehicle.

The invention relates to a method for operating the drive train of a motor vehicle, according to the preamble of patent claim 1, and to a method for operating the drive train of a motor vehicle, according to the preamble of patent claim 2.

DE 198 06 497 A1 describes a method for operating the drive train of a motor vehicle with an engine in the form of an internal combustion engine, with a transmission in the form of a manually shiftable shift transmission and with a friction clutch in the form of a frictional starting shift clutch. The friction clutch is arranged between the engine and the transmission and can be actuated by a vehicle driver by means of an actuation arrangement. When the friction clutch is completely closed, a control device in the form of slip control monitors a state of the friction clutch by comparing rotational speeds upstream and downstream of the friction clutch. When the control device detects a slip at the friction clutch, that is to say a rotational speed difference between the rotational speeds mentioned, it reduces an output torque of the engine for a limited time. The slip of the friction clutch is consequently lowered.

By contrast, the object of the invention is to propose a method for operating a drive train, by means of which method, while adhering as much as possible to a torque instruction of a vehicle driver, damage to the friction clutch and to further components of the transmission is avoided and a low-wear operation of the friction clutch becomes possible. The object is achieved, according to the invention, by means of a method as claimed in claim 1, and a method as claimed in claim 4.

When a friction clutch is operated with slip, energy in the form of heat is released at friction linings of the friction clutch. Part of the dissipated energy is discharged into the surroundings via the surface of the friction clutch, and, where what is known as a wet-running friction clutch is concerned, a further part is discharged to an operating medium. The undischarged energy leads to a warming or heating of the friction clutch, in particular of the friction linings. Excessive heating and consequently too high a temperature of the clutch may lead to damage and to increased wear on the clutch. With rising temperature, the radiation of energy into the surroundings also rises, which may also lead to an overheating of other components of the transmission which are arranged in the vicinity of the friction clutch.

By means of the method described in DE 198 06 497 A1, damage to the friction clutch is avoided only when the friction clutch is completely closed, that is to say no slip should occur at the friction clutch. However, there is also the risk of overheating precisely when the friction clutch is deliberately operated with slip, that is to say, for example, when the motor vehicle is started or in the case of a gear change.

According to the invention, with the friction clutch slipping, the control device determines an energy quantity dissipated in the friction clutch and/or a temperature of the friction clutch. The energy quantity is determined, for example, from the slip at the friction clutch, that is to say the rotational speed difference between the rotational speeds at the entrance and at the exit of the clutch, the output torque of the engine, the change in rotational speed of the engine and a mass moment of inertia of the engine. The temperature of the clutch may either be measured by means of suitable sensors or be calculated on the basis of a temperature model. By means of the temperature model, for example, the temperature of the clutch can be determined as a function of said energy quantity and of characteristic quantities for heat radiation. The determination of the energy quantity and/or of the temperature is carried out in all the operating ranges of the friction clutch, when the friction clutch is completely closed, that is to say no slip should occur, and when slip is deliberately set at the friction clutch.

The control device compares the energy quantity and/or the temperature with limit values. If the dissipated energy quantity and/or the temperature overshoot the limit values, the control device reduces the output torque of the engine. The control device may in this case either activate the engine directly or send a corresponding requirement to a further control device which then implements the requirement. The control device consequently reduces the output torque of the engine either directly or indirectly.

Consequently, by virtue of the method according to the invention, an overheating and overstressing of the friction clutch are prevented in all the operating ranges of the friction clutch. Damage-free and low-wear operation of the drive train thus becomes possible.

The engine may be designed, for example, as an internal combustion engine and the transmission as a manual shift transmission, an automated mechanical transmission, a multistep automatic transmission or a continuously variable transmission. The friction clutch, serving particularly as a starting clutch, may be designed as a clutch actuated by foot force or as an automated clutch.

According to the parallel claim 2, the control device determines a torque desired value by subtracting a reduction value from a current torque of the engine. The reduction value may be dependent on the slip of the friction clutch, on a specific energy quantity and/or on a specific temperature. The reduction value is, in particular, the higher, the higher is the slip, the energy quantity or the temperature.

The control device sets this torque desired value directly or indirectly on the engine. The current torque may correspond to the current output torque. Alternatively to this, the control device may store torque ranges and, for each range, a representative torque. The control device then checks in which range the output torque lies and uses the associated representative torque as the current torque.

According to the invention, after the reduction of the output torque of the engine has taken place, the state of the friction clutch continues to be monitored. In particular, a check is made as to whether slip continues to be present at the friction clutch and/or whether the temperature still lies above the limit value. On the basis of the monitoring result, particularly if one of said conditions is fulfilled, the torque desired value is reduced once again by a reduction value. The torque desired value may therefore be reduced in steps. The reduction values of the various reductions may in this case be equal or different.

Alternatively to this, the torque desired value could be reduced to a fixed value which could be dependent, for example, on the energy quantity and/or on the temperature.

As a result of the multiple reduction of the torque desired value, the reduction value can be made considerably lower, as compared with a once-only reduction of the output torque.

By contrast, the method according to the invention affords the advantage that the output torque of the engine is reduced only as little as possible. By virtue of the step-like reduction with multiple checking as to whether a further reduction is necessary, it is possible to reduce the torque as little as possible.

Each reduction has the effect that the wish of the vehicle driver which he instructs by means of a power control member cannot be implemented. Any intervention in the wish of the vehicle driver gives the latter an unpleasant feeling. This is the greater, the more the set torque differs from the wish of the vehicle driver. By virtue of the minimum possible reduction in the torque, a high degree of satisfaction of the vehicle driver is achieved and, at the same time, damage-free operation of the drive train is ensured.

In an embodiment of the invention, said limit values are dependent on operating variables of the motor vehicle and/or instructions of a vehicle driver and/or environmental variables. Operating variables are, for example, a temperature of the transmission, a selected gear of the transmission or a degree of actuation of the friction clutch. The degree of actuation of the friction clutch indicates how far the clutch is actuated between the two “completely open” and “completely closed” end positions. The instructions of the vehicle driver are, for example, a degree of actuation of a power control member or an actuation or degree of actuation of a brake of the motor vehicle. The brake may in this case be designed as a service brake and/or parking brake. Environmental variables describe the environment of the motor vehicle. The outside temperature is one example of an environmental variable.

Consequently, the limit values can be adapted to the conditions currently prevailing in and around the motor vehicle. A reduction in the output torque of the engine is therefore carried out only when it is necessary for damage-free operation of the drive train.

In an embodiment of the invention, said limit values are dependent on an actuation of a brake by the vehicle driver. With conditions otherwise being the same, the limit values are lower when the brake is actuated than when the brake is not actuated. In addition to the dependence on this digital decision, the limit values may also be dependent on the degree of actuation of the brake. Consequently, when the brake is actuated, the torque is reduced in the case of a lower dissipated energy quantity and/or in the case of a lower temperature of the clutch. The reduction therefore commences earlier.

When the motor vehicle is in operation, the vehicle driver can actuate the brake and the power control member simultaneously. The engine consequently has a torque output and a power output, under some circumstances without the vehicle moving forward. In any event, a high slip at the clutch is to be expected. This type of actuation constitutes a misuse of the motor vehicle in most instances. By the limit values being decreased, the torque is reduced more quickly, and consequently misuse and damage to the friction clutch or to the transmission are prevented.

In an embodiment of the invention, said limit values are dependent on a degree of actuation of a power control member. With conditions otherwise being the same, the limit values rise with a rising degree of actuation. The output torque of the engine likewise rises with a rising degree of actuation of the power control member. The degree of actuation constitutes a measure of the dynamics of the motor vehicle which the vehicle driver wishes. In addition to the degree of actuation, the limit values may also be dependent on variables which describe the type of driving of the vehicle driver, for example, sporty or steady.

Consequently, in the case of a demand of the vehicle driver for high dynamics of the motor vehicle, the torque may be reduced later, that is to say in the case of higher dissipated energy quantities and/or temperatures. This increases the degree of satisfaction of the vehicle driver. The limit values are, of course, varied only to an extent such that damage to the clutch or to the transmission continues to be reliably prevented.

In an embodiment of the invention, a number of overshoots of said limit values is determined and is stored in the control device. In this case, only the number or else further information, such as, for example, the duration of the overshoot, the dissipated energy quantity, the temperature of the friction clutch or a ratio of the duration of the overshoots to the overall operating time of the motor vehicle may be stored. Storage takes place in a nonvolatile memory, that is to say such that it is preserved after the motor vehicle has stopped.

Storage may also be carried out in conjunction with a method according to DE 198 06 497 A1.

This information can be read out when the motor vehicle spends time in a workshop. This makes it easy to diagnose any faults, and, moreover, may give indications as to a necessary exchange of components. When the motor vehicle is in operation, the information may be used to draw the vehicle driver's attention to a necessary check of the friction clutch or of the transmission, for example, by means of an indicator.

In an embodiment of the invention, the engine is designed as an internal combustion engine and has overrun fuel cutoff. When the overrun fuel cutoff is activated, the fuel is no longer injected and therefore fuel is saved. In this state, the engine is driven via the vehicle wheels. The overrun fuel cutoff is activated when a desired value for the output torque of the engine is lower than an overrun fuel cutoff torque, and when further conditions, for example the rotational speed of the engine is higher than a threshold value, are fulfilled. In the case of a reduction in the output torque of the engine, the torque desired value is always higher than said overrun fuel cutoff torque.

This prevents the situation where the overrun fuel cutoff is unintentionally activated in the event of a reduction in the torque. This would lead to unpleasant jolts in the drive train. Thus, even during the reduction in the torque, it becomes possible for the motor vehicle to operate comfortably.

In an embodiment of the invention, the control device determines at least one further torque desired value. A further torque desired value may be dependent, for example, on a selected gear in the transmission. Owing to mechanical conditions in the transmission, the transmission may, under certain circumstances, transmit less torque in various gears than the output torque of the engine. In this case, for each gear, a torque desired value is stored in the control device and is selected as a function of the gear.

Another possibility for a further torque desired value is, during starting, to determine a torque desired value as a function of the degree of actuation of the power control member and of a rotational speed of the engine. This prevents the situation where small changes in said variables lead to large changes in the engine torque. This improves the meterability of the output torque and avoids uncomfortable shifts.

The control device determines the minimum of the torque desired values and sets the determined minimum on the engine. Consequently, damage to the transmission is reliably ruled out and, at the same time, it becomes possible for the motor vehicle to operate comfortably.

In an embodiment of the invention, as soon as the slip at the friction clutch is lowered the torque desired value is increased in steps. As soon as slip no longer occurs at the friction clutch, further energy is no longer dissipated. The temperature of the friction clutch therefore no longer rises any further. The engine torque can consequently be increased again. In the case of an immediate increase to the instruction of the vehicle driver, there is the risk that slip occurs again immediately at the friction clutch. As a result of the increase in steps, which, in particular, takes place more slowly than the reduction in steps, a check can be made, after each step, as to whether slip occurs. Renewed slip is consequently detected very quickly and can be lowered again in a controlled manner by means of a further slight reduction. The lowering of the renewed slip can take place in a controlled manner, since the slip limit of the friction clutch is consequently known with high accuracy.

In an embodiment of the invention, the friction clutch is designed as an automated friction clutch. The friction clutch is therefore actuated by an actuator according to the control device. Simultaneously with a reduction in the output torque of the engine, during a starting operation the friction clutch is closed on the basis of an activation of the control device. A starting operation is detected, for example, when a speed of the vehicle lies below a limit value.

Consequently, even if the motor vehicle is actuated incorrectly by the vehicle driver, it becomes possible for the motor vehicle to be started without damage to the clutch or to the transmission.

Further embodiments of the invention may be gathered from the description and the drawing. Exemplary embodiments of the invention are illustrated in simplified form in the drawing and are explained in more detail in the following description. In the drawing:

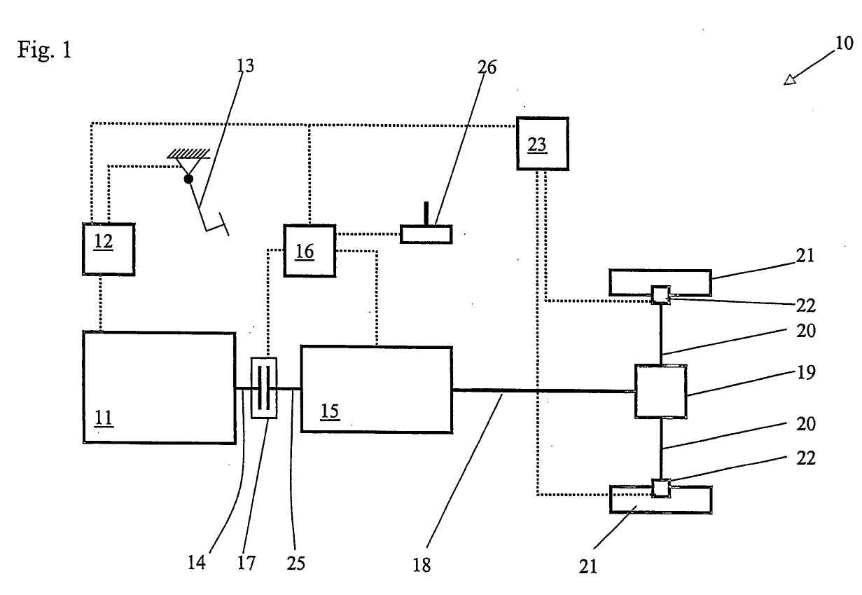

FIG. 1 shows a diagrammatic illustration of the drive train of a motor vehicle,

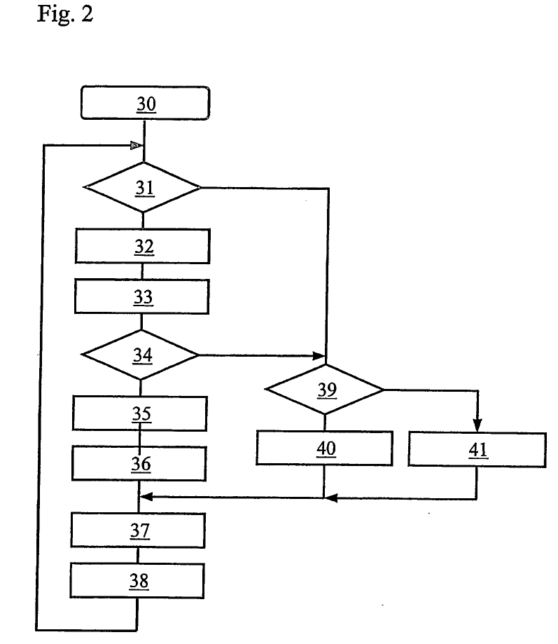

FIG. 2 shows a flow chart of a method for operating the drive train, and

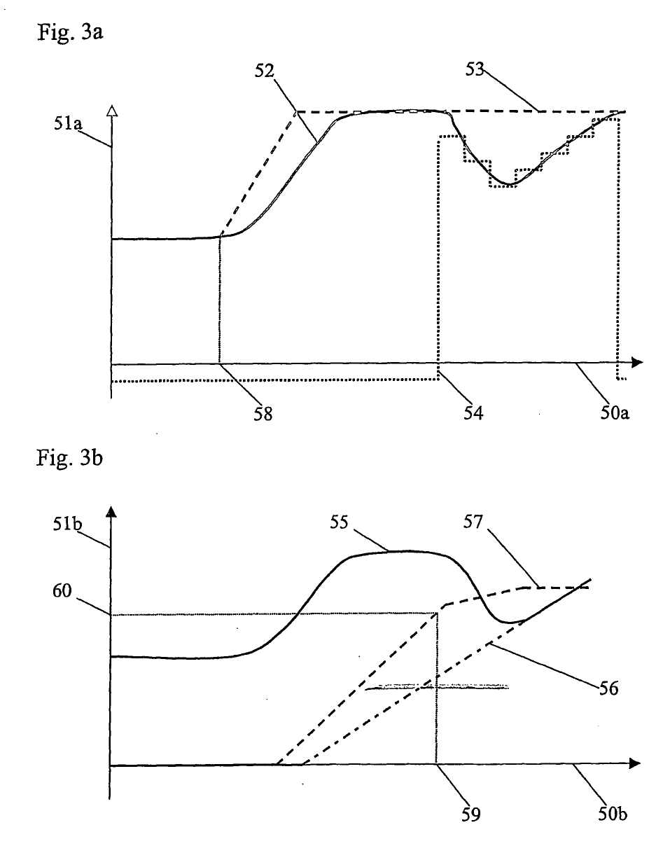

FIGS. 3a and 3b show in each case a graph for the time-related illustration of operating variables of the motor vehicle during a starting operation with a reduction of the output torque of the engine.

According to FIG. 1, a drive train 10 of a motor vehicle, not illustrated, has an engine 11 which is designed as an internal combustion engine and which is activated by a control device 12. For this purpose, the control device 12 is signal-connected to actuators, not illustrated, such as, for example, a throttle value actuator, and sensors, such as, for example, a rotational speed sensor for determining the rotational speed of the engine 11. Moreover, the control device 12 is signal-connected to a power control member 13 which is designed as an accelerator pedal and by means of which a vehicle driver can set an output torque of the engine 11. The degree of actuation of the power control member 13 is in this case a measure of the output torque of the engine 11. The higher the degree of actuation is, the higher is the output torque. The control device 12 can calculate from detected variables further operating variables of the engine 11, for example the output torque of the engine 11. The control device 12 can activate the actuators of the engine 11 in such a way that the engine 11 has a specific output torque. An overrun fuel cutoff function is integrated in the control device 12.

The engine 11 is connected via an output shaft 14 to a transmission 15 which is designed as an automated mechanical transmission and which is activated by a control device 16. For this purpose, the control device 16 is signal-connected to actuators, not illustrated, such as, for example, actuators for the selection and deselection of the various gears, and sensors, such as, for example, a rotational speed sensor for determining the rotational speed of a transmission input shaft 25. Moreover, the control device 16 is signal-connected to a shift lever 26, by means of which the vehicle driver can trigger shifts in the transmission 15.

Between the engine 11 and the transmission 15 is arranged an automated friction clutch 17 which is likewise activated by the control device 16. For this purpose, the control device 16 is signal-connected to a clutch actuation member, not illustrated. As a result of suitable activation of the clutch actuation member, the control device 16 can open or close the friction clutch 17.

The transmission 15 is connected by means of a drive shaft 18 to an axle transmission 19 which in a known way transmits the output torque of the engine 11 to driven vehicle wheels 21 via axle shafts 20.

Arranged on the vehicle wheels 21 are rotational speed sensors 22 which are signal-connected to a control device 23. By means of the rotational speed sensors 22, the control device 23 can detect a rotational speed of the vehicle wheels 21. The speed of the motor vehicle can be determined from these rotational speeds.

The control devices 12, 16 and 23 are signal-connected to one another via a serial bus connection, for example via a CAN bus. Consequently, detected variables, such as, for example, the rotational speed of the vehicle wheels 21, can be exchanged or requirements can be sent to a control device, for example the setting of a torque desired value can be sent from the control device 16 of the friction clutch 17 and of the transmission 15 to the control device 12 of the engine 11. The output torque of the engine 11 is in this case activated at least indirectly by the control device 16 of the friction clutch 17 and of the transmission 15.

The control device 16 determines a slip of the friction clutch 17 from the rotational speed of the engine 11 and the rotational speed of the transmission input shaft 25. As soon as slip occurs and the friction clutch 17 is at least partially closed, the control device 16 determines the dissipated energy quantity. When the energy quantity overshoots a limit value, the control device 16 demands a reduction in the output torque of the engine 11 which is implemented by the control device 12. As soon as slip is no longer present at the friction clutch 17, the reduction is canceled and the control device 12 again sets a torque corresponding to the degree of actuation of the power control member 13.

The friction clutch may also have arranged on it a temperature sensor by means of which the control device of the friction clutch can detect a temperature of the latter. In addition to measuring the temperature, the control device can also carry out a calculation of the temperature by means of a temperature model of the friction clutch. According to the comparison of the dissipated energy with a limit value, the measured or calculated temperature of the clutch can also be compared with a limit value. The procedure in the event of an overshoot of the limit value is identical to when the limit value is overshot by the energy quantity.

If the transmission does not have a rotational speed sensor, the rotational speed of the transmission input shaft may also be determined from the measured rotational speeds of the vehicle wheels and from the ratios in the axle transmission and in the transmission.

FIG. 2 illustrates a flow chart of a method for operating the drive train 10. The control device 16 runs through the method at a fixed time rate. The method starts in block 30. In the following interrogation block 31, a check is made as to whether slip is present at the friction clutch 17. For this purpose, a check is made as to whether the difference between the rotational speed of the engine 11 and that of the transmission input shaft 25 is higher than a limit value and the friction clutch 17 is at least partially closed.

If the check in the interrogation block 31 has a positive result, that is to say the slip is present, the method is continued in block 32. It may be mentioned, at this juncture, that, in all the interrogation blocks in FIG. 2, in the event of a positive result of the check, the method is continued downward correspondingly to the output of the interrogation block and, in the case of a negative result, the method is continued to the side correspondingly to the output.

In block 32, the energy quantity dissipated in the friction clutch is calculated. The energy quantity is calculated according to the following formula:
Eₜ=Eₜ₋₁+|dn|*|M_{AM}|*dt
in which:
Eₜ corresponds to the energy quantity at the time point t in [Joule],
Eₜ₋₁ corresponds to the energy quantity at the time point t-1 in [Joule],
   |dn| corresponds to the amount of the slip in [1/s] at the time point t,
   |M| corresponds to the amount of the output torque of the engine in [Nm] at the time point t, and
dt corresponds to a processing cycle time in [s].

In addition, the kinetic energy which is absorbed or discharged by the engine 11 in the event of a change in the rotational speed of the engine 11 can also be taken into account. The kinetic energy is dependent on a mass moment of inertia of the engine 11 and on a change in the rotational speed of the engine 11.

A limit value for the energy quantity is determined in the following block 33. The limit value is read out from tables as a function of the activation of the brake and of the degree of actuation of the power control member 13. The limit value is lower when the brake is actuated, as compared with the brake not being actuated. The limit value is higher in the case of a high degree of actuation of the power control member 13 than in the case of a low degree of actuation.

In the following interrogation block 34, a check is made as to whether the calculated energy quantity is higher than the limit value. If the result of the check is positive, in the following block 35 a counter filed in a nonvolatile memory is increased by one. The increase is carried out only once in the case of a multiple run through during a slipping action. The counter indicates how often an energy threshold has been overshot.

In the following block 36, the torque desired value is determined in that a reduction value is subtracted from the current output torque. Since the method is executed at a fixed time rate, there can be a multiple run through the block 36. In the case of a second reduction, the torque desired value is calculated by the reduction value being subtracted from the current torque desired value.

In the subsequent block 37, the minimum is determined from the torque desired value determined in block 36, from a gear-dependent torque desired value and from a torque desired value dependent on the rotational speed of the engine 11 and on the degree of activation of the power control member 13. The determined minimum is output, in block 38, to the control device 12 of the engine 11, which implements the instruction and sets the required torque. The method subsequently jumps back to interrogation block 31.

Owing to a multiple run through the blocks 32 to 38 in the event of a slipping action, the torque desired value can be reduced in steps.

If the interrogation in interrogation block 31 or in interrogation block 34 leads to a negative result, that is to say no slip is present or the energy quantity is no higher than the limit value, a check is made in the interrogation block 39 as to whether a torque reduction is active. For this purpose, a check is made as to whether a current torque desired value is present from block 36, and whether this torque desired value is lower than the torque corresponding to the degree of actuation of the power control member 13. If this is so, in block 40 the torque desired value is increased by an increase value, and, in block 37, the method is continued, being followed by the sequence described. Owing to a multiple run through block 40 in the event of a slipping action, the torque desired value can be increased in steps.

If the interrogation in the interrogation block 39 has a negative result, that is to say no limitation is active, then, in block 41, the torque desired value is set at a negative inactive value and consequently the reduction is deactivated on the basis of too high a dissipated energy in the friction clutch 17. The other limitations of the torque continue to remain active, so that the method is likewise continued in block 37.

FIGS. 3a and 3b illustrate the time profiles of operating variables of the motor vehicle during a starting operation with the reduction in the output torque of the engine.

In FIGS. 3a and 3b, the time is plotted on the abscissas 50a, 50b, torques are plotted on an ordinate 51a and rotational speeds and energy are plotted on an ordinate 51b.

FIG. 3a illustrates the output torque of the engine 11 (unbroken line 52), an instructed torque of the vehicle driver (dashed line 53) and a torque desired value (dotted line 54) for the purpose of reducing the output torque. FIG. 3b illustrates the rotational speed of the engine 11 (unbroken line 56), the rotational speed of the transmission input shaft 25 (dashed and dotted line 56) and the sum of the dissipated energy (dashed line 57).

At the time point 58, the motor vehicle is stationary and the vehicle driver, via the power control member 13, instructs an instructed torque for the output torque of the engine 11. On the basis of this, the torque and the rotational speed of the engine 11 rise. At the same time, the friction clutch 17 is closed slightly (not illustrated). Consequently, slip occurs at the friction clutch 17 and energy is dissipated, so that the line 57 likewise rises. With a further short delay, the rotational speed of the transmission input shaft 25 also rises, and the motor vehicle is set in motion. The slip continues to persist, so that the sum of dissipated energy increases further. At the time point 59, the energy overshoots a limit value 60, whereupon the torque desired value jumps from a negative inactive value to a value which is lower by a reduction value than the output torque of the engine 11 of the time point 59. As a result of this, the output torque and the rotational speed of the engine 11 fall, that is to say less energy is released, and the sum rises more slowly. However, since the slip has not yet been lowered completely, the torque desired value is in each case reduced further in steps by the reduction value. At the same time, the friction clutch 17 is closed completely, so that the slip is lowered and the rotational speeds of the engine 11 and of the transmission input shaft 25 become equal. The torque desired value is thereupon increased again in steps in each case by an increase value. As soon as the torque desired value becomes higher than the instructed torque, the torque desired value jumps to the inactive value again. The vehicle drive can consequently instruct the torque again and accelerate the motor vehicle further.

1-11. (canceled)

12. A method for operating the drive train of a motor vehicle which has
an engine,
a transmission and
a friction clutch arranged between the engine and transmission,
a control device monitoring a state of the friction clutch and reducing an output torque of the engine on the basis of a monitoring result,
characterized
in that the control device,
with the friction clutch slipping, determines an energy quantity dissipated in the friction clutch and/or a temperature of the friction clutch,
compares the engine quantity and/or the temperature with limit values, and
reduces the output torque of the engine in the event of the overshooting of one or of both limit values.

13. A method for operating the drive train of a motor vehicle which has
an engine,
a transmission and
a friction clutch arranged between the engine and transmission,
a control device monitoring a state of the friction clutch and reducing an output torque of the engine to a torque desired value on the basis of a monitoring result, and the torque desired value being determined by a reduction value being subtracted from a current torque of the engine,
characterized
in that, after the reduction in the output torque of the engine has taken place, the state of the friction clutch continues to be monitored, and the torque desired value is reduced once again by a reduction value on the basis of the monitoring result.

14. The method as claimed in claim 12, characterized in that
the control device determines a torque desired value by subtracting a reduction value from a current torque of the engine,
the torque desired value is set on the engine, and,
after the reduction in the output torque of the engine has taken place, the state of the friction clutch continues to be monitored, and
the torque desired value is reduced once again by a reduction value on the basis of the monitoring result.

15. The method as claimed in claim 12,
characterized in that said limit values are dependent on
operating variables of the motor vehicle and/or
instructions of a vehicle driver and/or
environmental variables.

16. The method as claimed in claim 15, characterized in that said limit values
are dependent on an actuation of a brake by the vehicle driver and
are lower when the brake is actuated than when the brake is not actuated.

17. The method as claimed in claim 15, characterized in that said limit values
are dependent on a degree of actuation of a power control member and
rise with a rising degree of actuation.

18. The method as claimed in claim 12, characterized in that a number of overshoots of said limit values is determined and is stored in the control device.

19. The method as claimed in claim 12, characterized in that
the engine is designed as an internal combustion engine,
the engine has an overrun fuel cutoff which is activated when a desired value for the output torque of the engine is lower than an overrun fuel cutoff torque, and,
in the event of a reduction in the output torque of the engine, the torque desired value is always higher than said overrun fuel cutoff torque.

20. The method as claimed in claim 12, characterized in that
the control device determines at least one further torque desired value,
the minimum of the torque desired values is determined, and
the determined minimum is set on the engine.

21. The method as claimed in claim 12, characterized in that, as soon as the slip of the friction clutch is lowered, the torque desired value is increased in steps.

22. The method as claimed in claim 12, characterized in that
the friction clutch is designed as an automated friction clutch, and,
during a starting operation, the friction clutch is closed simultaneously with a reduction in the output torque of the engine.
